(19) United States
(12) Patent Application Publication
(10) Pub. No.: US 2009/0172549 A1
(43) Pub. Date: Jul. 2, 2009

(54) METHOD AND APPARATUS FOR TRANSITIONING BETWEEN SCREEN PRESENTATIONS ON A DISPLAY OF AN ELECTRONIC DEVICE

(75) Inventor: Andrew W. Davidson, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/966,154

(22) Filed: Dec. 28, 2007

(51) Int. Cl. G06F 3/00

(52) U.S. Cl. 715/732

(57) ABSTRACT

A method and apparatus for transitioning between screen presentations on a display of an electronic device includes determining a selection by a user of the electronic device of one of a plurality of dynamic transition themes, detecting an event that causes a transition from a current screen presentation to a replacement screen presentation, and applying the selected dynamic transition theme to the dynamic transition when it is in a set of allowed dynamic transitions. Each dynamic transition theme defines a manipulation of a plurality of manipulable objects that are in any dynamic transition in the allowed set of dynamic transitions. Each dynamic transition consists of a current screen presentation and replacement screen presentation and comprises a plurality of manipulable objects. The manipulations are performed according to a pattern defined by the dynamic transition theme. The set of allowed dynamic transitions includes substantially all dynamic transitions.

### FIELD OF THE DISCLOSURE

The present disclosure relates generally to electronic devices having a display for user interface and more particularly to manipulating screen presentations.

### BACKGROUND

Many electronic devices use a screen or display for user interface. These include movie projectors, TV's, computers, electronic games, and personal electronic devices such as cellular telephones. In order to attract users to view presentations on these devices, techniques of adding interesting visual effects between scenes or slides have been used for many years. Among these are the techniques used in Microsoft's PowerPoint applications, published by Microsoft Corporation and Adobe's Photoshop Elements applications, published by Adobe Systems, Inc.

These applications offer to a user who is putting together a slide show a choice of one of several slide transition techniques. For example, in Adobe Photoshop Elements version 5.0, the following transition effects are offered: Barn Door, Box Wipe, Center Wipe, Checker Wipe, Clock Wipe, Dissolve, Fade, and Gradient Wipe. Microsoft Powerpoint as provided in Microsoft Office Small Business 2007, version 12.0.4518.1014 offers the following transitions: Blinds Horizontal, Blinds Vertical, Box In, Box Out, Checkerboard Across, Checkerboard Down, Comb Horizontal, Comb Vertical, which are included in a set that includes five transitions categorized as Fades and Dissolves, 32 categorized as Wipes, and 12 categorized as Push and Cover. These transitions may be selected by a user an applied to single transitions within a slide show or to all transitions of a slide show that the user is putting together. All of these Adobe and Microsoft transitions perform a visual manipulation that is independent of the objects being displayed on either the current or new slide.

In Microsoft Powerpoint, an additional technique called custom animation is offered that allows a user to identify objects within a slide and select an effect for that object in that slide, for which the effect occurs based upon a mouseclick event that occurs while the slide is being presented. Objects may include words, characters, phrases, or images that are separate objects in the slide. The effects are classified as Entrance, Exit, Emphasis, and Motion effects. The Entrance and Exit effects are similar to the transitions, but are applied to an object. The Emphasis effects in include size changes and spinning. The motions include several linear, defined motions, and a user definable constant velocity trajectory.

In order to attract customers in the highly competitive business of personal communication devices, personal communication device manufacturers seek to include interesting features, but the use of screen presentation transition techniques has been limited or non-existent.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a personal communication, in accordance with certain embodiments.

FIG. 2 is a flowchart 200 that shows of some steps of a method for transitioning between the screen presentations on a display on electronic device is shown, in accordance with certain embodiments.

FIG. 3 is a flow chart that shows some detail of a step of the method described with reference to FIG., in accordance with certain embodiments.

FIGS. 4-18 are three series of figures that show positions of manipulable objects during three different dynamic transition examples, in accordance with certain embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In certain embodiments, a method is used for transitioning between screen presentations on a display of an electronic device. In some of these embodiments, the method may be described as including steps, or functions, of determining a selection by a user of the electronic device of one of a plurality of dynamic transition themes, detecting an event that causes a transition from a current screen presentation to a replacement screen presentation, and applying the selected dynamic transition theme to the transition when it is in the set of dynamic transitions. In the step of determining a selection by a user, each dynamic transition theme is characterized in that it defines a manipulation of a plurality of manipulable objects that are in any dynamic transition in a set of dynamic transitions in which each dynamic transition in the set consists of a current screen presentation and replacement screen presentation. At least one of the current and replacement screen presentations is a dynamically transitionable screen presentation comprising a plurality of manipulable objects. The manipulations are performed according to a pattern defined by the dynamic transition theme.

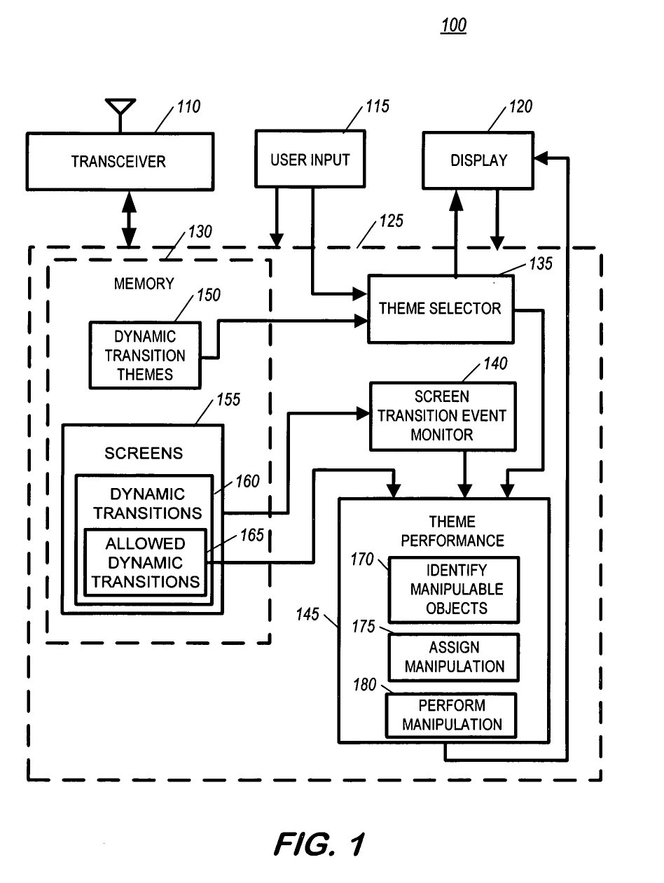

Referring to FIG. 1, a block diagram of a personal communication device 100 is shown, in accordance with certain embodiments. The personal communication device 100 may comprise hardware that is currently available in many cellular telephones, except that the hardware includes memory that is uniquely programmed with software to provide the unique functions of the embodiments. Although the embodiments described herein with reference to FIG. 1 are described in the context of the personal communication device, it will be appreciated that the benefits provided for users of a personal communication device are also provided for users of other electronic devices; the inclusion of a transceiver is not necessary. However a personal communication device is used to describe certain embodiments because users of personal communication devices may appreciate the benefits provided by the embodiments more than users of some other electronic devices, because the benefits include easy set up and very interesting effects.

The personal communication device 100 includes a transceiver 110, a user input modality 115, a display 120, and a processing system 125. The transceiver 110 may comprise a cellular telephone transceiver, a public safety transceiver, a local area network transceiver, or any other transceiver used in a personal navigation device. The user input modality 115 is coupled to the processing system 125 for the processing system 125 which can accept inputs from the user input 115 and process them. In a specific instance the user input modality 115 is coupled to a theme selector function 135 of the processing system 125. The display 120 is also coupled to the processing system 125 which couples display outputs to the display 120. In a specific instance the display 120 is coupled to a theme performance function 145 of the processing system 125.

The processing system 125 of the personal communication device 100 comprises memory and 130 and a processing unit (not shown in FIG. 1). The memory 130 comprises a portion that stores programming instructions, including a set of programming instructions unique to the embodiments (not shown in FIG. 1), a portion that stores a plurality of dynamic transition themes 150, and a portion that stores presentation screens 155. Each dynamic transition theme defines a pattern of manipulations that are performed on manipulable objects that are within a screen presentation being presented on the display 120. The plurality of dynamic transition themes 150 are coupled to the theme selector function 135 which interacts with user input modality 115 to determine which of the plurality of dynamic transition themes 150 a user selects. The theme selector 135 may also interact with the display 120 in order to determine the user selection. The theme selector 135 is further coupled to the theme performance function 145.

The processing system 125 further includes a screen transition event monitor 140, which detects events generated by the processing system 125 and determines which of those are screen transition events. Such events may be generated by the user such as when the user generates a command to change, for example, from a home screen to a main menu screen, or generates a command to accept entries that have been made to add a new contact, thereby causing a change from a screen used for editing a contact to a screen which says contact accepted. Many other examples of screen transitions are well-known to ordinary users of cellular telephones and other personal devices. When the screen transition event monitor 140 determines that screen transition event has occurred, the screen transition event monitor 140 determines whether the screen transition falls within a class of dynamic transitions 160 that are identified as being modifiable by themes, identified as set of themes 165 in FIG. The set of dynamic transitions 160 is shown as being stored in a portion of the memory 130 that is reserved for screens 155. The set of dynamic transitions 160 is one in which each member is a dynamic transition that consists of a current screen presentation and replacement screen presentation, and for which at least one of the current and replacement screen presentations is a dynamically transition of all screen presentation comprising a plurality of manipulable objects. “Manipulable objects” refers to visibly identifiable objects that are presented in a screen presentation on display 120. In accordance with certain embodiments the set of dynamic transitions that are modifiable by themes 165 comprises all dynamic transitions. In accordance with other embodiments the set of dynamic transitions that are modifiable by themes 165 includes substantially all dynamic transitions 160, excluding at most a small minority that are not allowed to be modified by themes, either by a default setting in the electronic device 100 or, in some embodiments, by a user selection. In some embodiments, a small minority may be as large as 25% of dynamic screen transitions. In some embodiments, it may be less, such as being no larger than 1% of all dynamic screen transitions. Identification of a dynamic transition as being not allowed to be modified by themes might be used, for example, in a transition from any screen to an emergency screen for which speed of use is deemed vital. It should be noted that screen presentations for which the display area is used wholly or substantially (for example, greater than 50% of the display area) for a video presentation may not be considered to be dynamically transitionable screens, in certain embodiments, since the effects would be confusing rather than pleasing

When the screen transition event monitor 140 has determined that there is a screen transition event applicable to a dynamic transition that is modifiable by themes, the screen transition event monitor 140 sends a command to the theme performance function 145 to initiate a screen transition according to the theme selected by the user. The selected dynamic transition theme is coupled to the theme performance function 145 by the theme selector 135. The theme performance function 145 then applies the selected dynamic transition theme to the screens involved in the dynamic transition (the current screen presentation and the new replacement screen presentation), manipulating the manipulable objects according to a pattern defined by the selected dynamic transition theme. The theme performance function 145 may comprise a function that identifies manipulable objects 170 in the screens of the dynamic transition, a function that assigns a manipulation 175 to each manipulable object that has been identified, and a function to perform the manipulations 180. The function that assigns a manipulation 175 may use a set of rules that are included in the pattern of the dynamic transition theme to determine the assignment of the manipulations. The set of rules is capable of determining manipulations for a varying number of manipulable objects in different dynamic transition screens 155. It will be appreciated that the electronic device 100 may include conventional capabilities for rendering images and text simultaneously on the display 120 (which acts as the primary output device for human interface for the electronic device). Such capabilities may be provided by a display having a display interface that meets standards commonly known as the scalable vector graphics standard. The electronic device 100 may further include conventional functions capable of identifying and animating such images and text (i.e., the manipulable objects). The functions may be conventional run time tools that apply an animation scheme defined in a conventional computer language such as the Synchronized Multimedia Integration Language (SMIL) or the Javascript® language distributed by Sun Microsystems, Inc. Santa Clara Calif. to the manipulable objects.

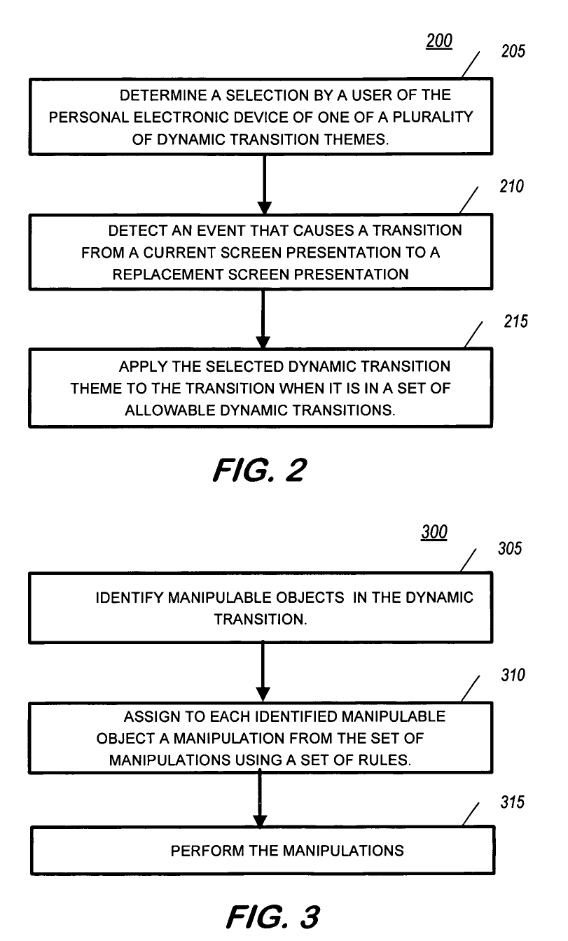

Referring to FIG. 2, a flowchart 200 of some steps of a method for transitioning between the screen presentations on a display on electronic device is shown, in accordance with certain embodiments. At step 205 a selection is determined by a user of the electronic device of one of a plurality of dynamic transition themes. Each dynamic transition theme is characterized in that it defines a manipulation of a plurality of manipulable objects that are in any dynamic transition in an allowed set of dynamic transitions. Each dynamic transition consists of a current screen presentation and a replacement screen presentation. Each manipulable object may comprise pixels of a visibly independent portion of the screen presentation. Each manipulable pixel may comprise a least one word or may comprise all pixels within a visible boundary or may comprise an icon. The meaning of “word” in this context means any symbol string that excludes spaces and that is delimited by spaces. Objects that are within a video presentation may be excluded from the definition of manipulable objects in certain embodiments. In each dynamic transition, at least one of the current and replacement screen presentations is a dynamically transitionable screen presentation. A dynamically transitionable screen presentation comprises a plurality of manipulable objects. The manipulations are performed according to a pattern that is defined by the dynamic transition theme. At step 210 and event is detected that causes a transition from a current screen presentation to replacement screen presentation. Such events could be initiated by such things as detectable user actions, the receipt of a message or phone call, or the occurrence of a defined time, just to name a few. At step 215 be selected dynamic transition theme is applied to the dynamic transition, causing the manipulable objects in the dynamic transition to be manipulated according to the pattern. In certain embodiments, each manipulation comprises either being moved in a trajectory or being altered in appearance, or both. A trajectory can, for the purposes of this document, include rotational motion of the object about a defined point within the object and/or motion of the point of the object, either of which may be nonlinear. Being altered in appearance includes a change in size, shape, or one or more color regions of the manipulable object.

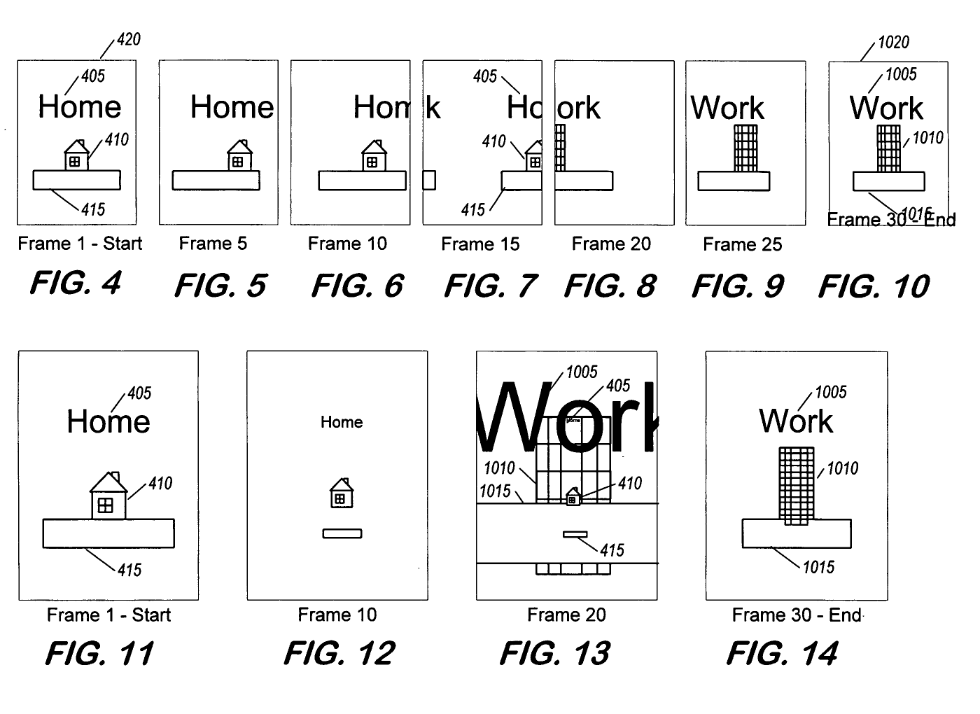

Referring to FIG. 3, a flow chart 300 shows some steps of a method that provides detail of step 215 of FIG. 2, in accordance with certain embodiments. At step 305 manipulable objects are identified in the dynamic transition. They may appear in the current screen presentation or the replacement screen presentation or both. At step 310 a manipulation from a set of manipulations defined in the pattern of the dynamic theme is assigned to each identified manipulable object using a set of assignment rules applicable for a varying number of manipulable objects, since different dynamically transitionable screens may have different numbers of manipulable objects. For example a dynamically transitionable screen that includes a vertical list of items that may vary in length. The manipulable objects may be identified in an indexed fashion from top to bottom in the manipulations may likewise be defined in an indexed manner. When the manipulations of the assigned in step 310 manipulations may then we performed in step 315. Stated in another way, the identified manipulable objects are indexed in the step of identifying manipulable objects 305 and the manipulations from the set of manipulations are indexed and the rule is to match a necessary quantity of indexed manipulations having lowest indices on a one for one basis to the indexed, identified manipulable objects.

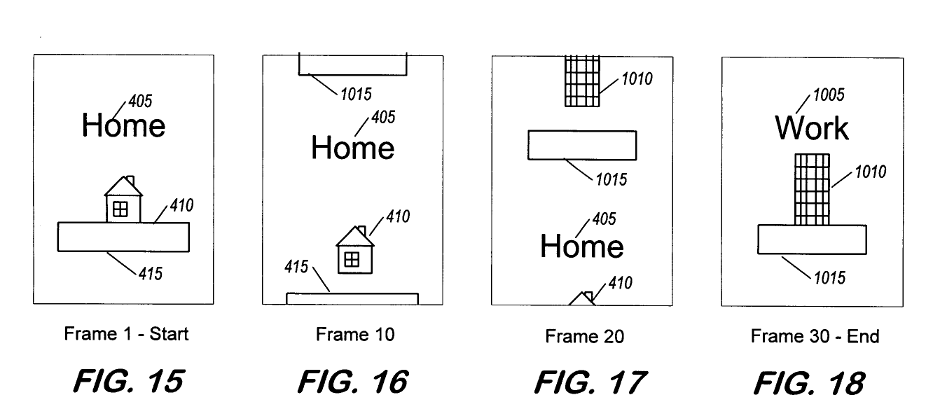

Referring now to FIGS. 4-10, a series of figures show the positions of manipulable objects during a dynamic transition example named a racing animation theme, in accordance with certain embodiments. FIG. 4 illustrates three manipulable objects 405, 410, 415 that are presented in a portion 420 of a current screen presentation of a dynamically transitionable screen, at the start of a dynamic transition. The three manipulable objects are the word home 405, an icon for a home 410, and a base 415. FIG. 10 illustrates three other manipulable objects 1005, 1010, 1015 that are presented in a portion 1020 of the replacement screen presentation of a dynamically transitionable screen, at the end of the dynamic transition. The three manipulable objects are the word work 1005, an office tower 1010, and a base 1015. The impression of movement of the manipulable objects during the dynamic transition is presented to the user by a series of 30 frames with FIG. 4 being frame one and FIG. 10 being frame 30. In FIG. 5, the manipulable objects of the current dynamically transitionable screen as it would appear in frame five of the series of 30 frames. It can be seen in FIG. 5 that the average speed of the house icon 410 has been greater than the average speed of the word home 405 or the average speed of the base 415. However referring to FIGS. 6 and 7, it can be seen that the average speed of the house icon 410 by frame 15, which is FIG. 7, is approximately the same as the average speed of the word home 405 and the average speed of the base 415. A similar situation is shown in FIGS. 8-10 for the office tower 1010. This illustrates that a trajectory does not have to have a constant velocity.

Referring to FIGS. 11-14, a series of figures show positions of manipulable objects 405-415, 1005-1015 during a dynamic transition example named a shrinking animation theme, in accordance with certain embodiments. As in the situation described with reference to FIGS. 4-10, 30 frames are presented to the user to provide the appearance of motion of the manipulable objects, which may represent only a portion of a screen. The same manipulable objects 405-415, 1005-1015 are presented in FIGS. 11-14 as were presented in FIGS. 4-10. In FIG. 12, which is frame 10 of this series of 30 frames, the manipulable objects can be seen to be in their original positions but shrinking. By frame 20 in FIG. 13 the manipulable objects from the current dynamically transitionable screen presentation have become very small and the manipulable objects for the replacement dynamically transitionable screen presentation have appeared in very large size, but in their final positions.

Referring to FIGS. 15-18, a series of figures show the positions of manipulable objects 405-415, 1005-1015 during a dynamic transition example named a gravity animation theme, in accordance with certain embodiments. As in the situation described with reference to FIGS. 4-14, 30 frames are presented to the user to provide the appearance of motion of the manipulable objects which may represent only a portion of the screen. The same manipulable objects 405-415, 1005-1015 are presented in FIGS. 15-18 as were presented in FIGS. 4-14. By viewing FIGS. 15-18, it can be seen that the manipulable objects are moving downward with differing and changing velocities. In accordance with certain embodiments, the trajectories for manipulating the manipulable objects are defined as a part of the dynamic transition theme and therefore do not to be selected by the user. Only the theme need be selected by the user and the theme will be applied by default to all dynamic transitions in the set of allowable dynamic transitions. Furthermore, the user need not be involved in determining the set of allowable dynamic transitions. Therefore the user is able to easily select a very interesting dynamic transition theme and quickly apply it to most dynamic screen transitions.

Although FIGS. 4-18 show straight line trajectories, embodiments are not restricted to straight line motion. For example, spirals could be used. In order to assign them to a varying number of manipulable objects, the spirals could be translated by a defined amount of rotation, which would provide an easy indexing scheme. Or random trajectories could be defined. In one example, a random velocity could be assigned for each manipulable object for each 3 of 30 frames of a transition by choosing a random value within a defined range for each of an x and y coordinates of the velocity. By applying the dynamic transition theme to many differing screen transitions (i.e., to many different pairs of current screen—replacement screen transitions), even an individual dynamic transition that may seem unpatterned is likely to seem patterned due to its use for many different transitions.

Although the embodiments have been largely described above in the form of a personal communication device, it will be appreciated that the embodiments could be in the form of any electronic device that has a user interface that employs a plurality of different screen presentations on a display, for which one example is a television set top box that uses the television display to interface to the set top box.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, or as specifically stated herein above. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for transitioning between screen presentations on a display of an electronic device, comprising:
determining a selection by a user of the electronic device of one of a plurality of dynamic transition themes, each of which is characterized in that it defines a manipulation of a plurality of manipulable objects that are in any dynamic transition in an allowed set of dynamic transitions, wherein each dynamic transition consists of a current screen presentation and replacement screen presentation, and wherein at least one of the current and replacement screen presentations is a dynamically transitionable screen presentation comprising a plurality of manipulable objects, and wherein the manipulations are performed according to a pattern defined by the dynamic transition theme;
detecting an event that causes a transition from a current screen presentation to a replacement screen presentation; and
applying the selected dynamic transition theme to the dynamic transition when it is in the set of allowed dynamic transitions.

2. The method according to claim 1, wherein each manipulable object comprises pixels of a visibly independent portion of a screen presentation.

3. The method according to claim 1, wherein each manipulable object comprises at least one word, wherein a word is any symbol string that excludes spaces and is delimited by spaces, all pixels within a visible boundary, and an icon.

4. The method according to claim 3, wherein objects in a video presentation may be excluded as manipulable objects.

5. The method according to claim 1, wherein each manipulable object is manipulable by at least of one being moved in a trajectory and being altered in appearance.

6. The method according to claim 5, wherein being altered in appearance includes a change in size, shape, or one or more color regions of the manipulable object.

7. The method according to claim 1, wherein the set of allowed dynamic transitions comprises substantially all screen transitions that involve at least one dynamically transitionable screen.

8. The method according to claim 7, wherein substantially all screen transitions is determined by excluding no more than 25% of all screen transitions that involve at least one manipulable object.

9. The method according to claim 1, wherein the pattern is defined by a set of manipulations and wherein applying the selected dynamic transition theme further comprises
identifying manipulable objects in the dynamic transition;
assigning to each identified manipulable object a manipulation from the set of manipulations using a set of assignment rules; and
performing the manipulations.

10. The method according to claim 9, wherein the identified manipulable objects are indexed in the step of identifying manipulable objects and the manipulations from the set of manipulations are indexed and the rule is to match a necessary quantity of indexed manipulations having lowest indices on a one for one basis to the identified manipulable objects.

11. An apparatus for transitioning between screen presentations on a display of an electronic device, comprising:
a display;
a user input modality; and
a processing system that is coupled to the display and user input modality, the processing system comprising memory and a processing unit, wherein the memory comprises programmed instructions that control the processing system to
determine a selection by a user of the electronic device of one of a plurality of dynamic transition themes, each of which is characterized in that it defines a manipulation of a plurality of manipulable objects that are in any dynamic transition in an allowed set of dynamic transitions, wherein each dynamic transition consists of a current screen presentation and replacement screen presentation, and wherein at least one of the current and replacement screen presentations is a dynamically transitionable screen presentation comprising a plurality of manipulable objects, and wherein the manipulations are performed according to a pattern defined by the dynamic transition theme;
detect an event that causes a transition from a current screen presentation to a replacement screen presentation; and
apply the selected dynamic transition theme to the transition when it is in the set of allowed dynamic transitions.

12. The apparatus according to claim 11, wherein the programming instructions that control the processing system to apply the selected dynamic transition theme comprise programming instructions that control the processing system to
identify manipulable objects in the dynamic transition;
assign to each identified manipulable object a manipulation from the set of manipulations using a set of assignment rules; and
perform the manipulations.
